(19) United States
(12) Patent Application Publication
(10) Pub. No.: US 2005/0237397 A1
(43) Pub. Date: Oct. 27, 2005

(54) Image capture

(76) Inventors: Maurizio Pilu, Bristol (GB); Marco Casassa Mont, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/114,525

(22) Filed: Apr. 26, 2005

(30) Foreign Application Priority Data
Apr. 27, 2004 (GB) 0409333.2

(51) Int. Cl. H04N 5/76

(52) U.S. Cl. 348/231.99

(57) ABSTRACT

Method and apparatus for enabling an imaging function of a mobile device in areas where use of such imaging functions is prohibited, including registering image data in the device in order to determine if such data relates to the image of a face of a user of the device, and on the basis of the determination, enabling an imaging function of the device proper.

### TECHNICAL FIELD

The present invention relates to the field of image capture.

### CLAIM TO PRIORITY

This application claims priority to copending United Kingdom utility application entitled, “IMAGE CAPTURE,” having serial no. GB 0409333.2, filed Apr. 27, 2004, which is entirely incorporated herein by reference.

### BACKGROUND

Portable digital cameras have become miniaturized, and are becoming increasingly more wide-spread. Known mobile devices already have in built cameras, and picture messaging between mobile phones, for example, is an increasingly used technology.

Further, wearable cameras are known, and with the ever decreasing cost and size of imaging devices and storage, have the potential for becoming widely used consumer products.

Under certain circumstances, being included in photographs or picture messages taken by devices such as those described above has a nuisance effect for some people. Increasing usage of portable camera devices means that the privacy issue of capturing images of subjects who would prefer not to be photographed is greater than before. Because portable cameras are small and may be unseen by a subject, people cannot in general choose to avoid being in the field of view of a small portable camera and may have their picture taken without their knowledge or consent.

There are known systems for preventing the use of the imaging function of an imaging device.

In JP 10031265 there is disclosed a device for preventing stealthy photographing in which a remote control receiver is provided for remote control in a camera, where the remote control receiver issues a warning sound when a camera captures an image.

In U.S. publication 2001/0016820, there is disclosed a face identification system, whereby faces are removed from a memory of a device once identified.

In JP 2001235812 there is disclosed an image processing method in a digital photographic processing device in which a digital processing device is provided with a masking pattern which can be super-imposed on a portion of an image for obscuring that portion of the image.

The ImageId company has a known product, whereby a user can wear a tag. The tags are recognized by cameras and can be used to sort out images of people. The system recognizes and reads a set of markings within an image, and then sorts and stores matching identification codes in a database.

In U.S. Pat. No. 6,067,399 there is disclosed a privacy mode for cameras and camcorders. Images of faces recorded on a camera or camcorder may be detected and obscured.

In certain circumstances, it will be desirable, or even necessary, to use an imaging function of a mobile device in areas where use of such imaging apparatus is prohibited.

### SUMMARY

According to a first embodiment, there is provided a mobile device including a processor, the processor operable to determine if use of an imaging function of an image capture element of the device is prohibited, wherein, on the basis of the determination, the processor is adapted to process image data registered using the image capture element in order to facilitate determination that the registered image data corresponds to data stored in a memory associated with the device and is further operable to enable an imaging function of the device on the basis of this determination.

According to a second embodiment, there is provided a method of enabling an imaging function of a mobile device, the method including determining if use of an imaging function of an image capture element of the device is prohibited on the basis of the determination, registering image data using the image capture element of the device processing the registered image data determining, on the basis of the processing, if the registered image data corresponds to data stored in a memory associated with the device, and enabling an imaging function of the device on the basis of this determination.

According to a third embodiment, there is provided a mobile device including means for determining if use of an imaging function of an image capture element of the device is prohibited means for registering image data using the image capture element of the device means for processing the registered image data means for determining if the registered image data corresponds to data stored in a memory associated with the device, and means for enabling an imaging function of the device.

### BRIEF DESCRIPTION OF THE DRAWINGS

For a better understanding of the present invention, and to further highlight the ways in which it may be brought into effect, various embodiments will now be described, by way of example only, with reference to the following drawings in which:

FIG. 1 is a diagrammatic representation of a mobile communications device;

FIG. 2 is a flow chart diagrammatically representing a procedure for enabling an imaging function of a mobile device;

FIG. 3 is a diagrammatic representation of an image; and

FIG. 4 is a diagrammatic representation of some elements of an image capture device.

It should be emphasised that the term “comprises/comprising” when used in this specification specifies the presence of stated features, integers, steps or components but does not preclude the presence or addition of one or more other features, integers, steps, components or groups thereof.

### DETAILED DESCRIPTION

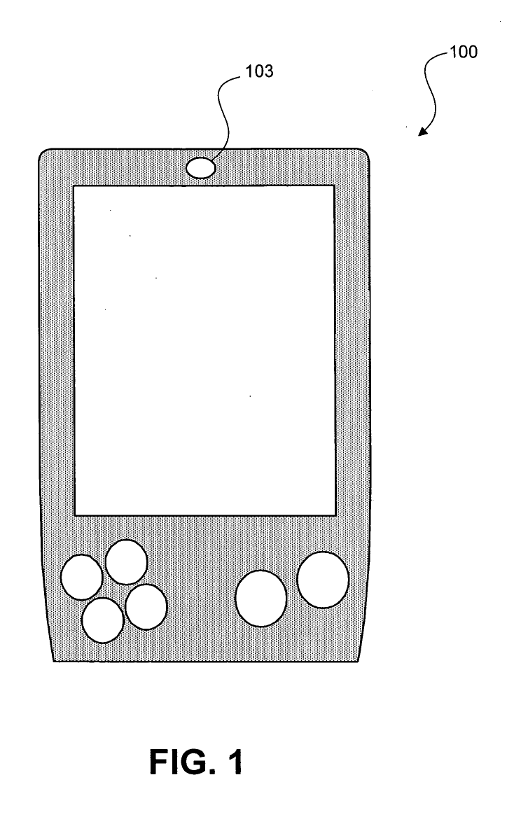

FIG. 1 of the accompanying drawings is a diagrammatic representation of a mobile device 100 which includes an image capture element 103.

The device of FIG. 1 may be a mobile station such as a mobile telephone, or a personal digital assistant, or a pager, for example. In general, the device of FIG. 1 may be any mobile device with imaging capabilities and which is operable to transmit and/or receive data using a wireless communications network, such as a radio frequency wireless communications network for example or alternatively using a hard-wired network or a combination thereof. The image capture element 103 of the device 100 may be a charge-coupled device (CCD) or a complementary metal oxide semiconductor (CMOS) device, for example, as is customary in the art.

The image capture element 103 of the device 100 is operable to perform an imaging function of the device. For example, the element 103 is operable, in association with other parts of the device 100 (not shown) to take still photographs or video sequences, or a combination of the two. In the case that the device 100 of FIG. 1 is used for videoconferencing, the element 103 is operable to capture at least video. The element 103 will, in general, be protected from the external environment with a transparent cover which may have additional optical properties for filtering or focussing of light for example.

In situations where the use of an imaging function of the device 100 is prohibited, such as in those situations as described above, an imaging function (such as still or video image capture for example) of the device 100 will be prevented from operating properly, or will be prohibited.

For example, an area in which an imaging function is prohibited from being used may be subject to emission of a signal to which a device, such as device 100, may react, causing the device 100 to disable an imaging function of the device in that area. Such a ‘prohibition signal’ will generally be transmitted over a pre-defined area in which use of an imaging function of a mobile device is to be impeded or prohibited and will typically be received by device 100 via an antenna of the device. In this case, the prohibition signal may be a radio frequency signal for example. However, in certain circumstances, other signals may be used such as optical signals for example. In this case, the device 100 is operable to receive such signals via its imaging element or other optical reception means such as a suitable photodetector for example. The prohibition signal may be transmitted from a stationary point in a location such as a particular point in a museum for example, or may be transmitted from a device on a person thereby prohibiting the use of an imaging function of a device in their immediate vicinity.

In certain circumstances however, it will be desirable, or even necessary to use an imaging function of a device where such prohibition is in place. In addition, when the imaging function of a device is to be used for predominantly personal reasons, such as performing a videoconference using the image capture element 103 of the device 100 for example, such a prohibition will generally prove unnecessary since no images of third parties will be or are intended to be captured by a user of the device.

In this respect, it is desirable to override the prohibition of use of an imaging function of a device.

According to an exemplary embodiment, the device 100 is operable, in such circumstances, to continue to register image data from light incident on the element 103. Such image data registration will enable the device to process the data using a suitably programmed processor of the device (not shown) in order to determine the nature of the data. The device 100 is therefore operable to receive image data, even in areas where an imaging function is inhibited, but any data registered by the device via the image capture element 103 is not committed to a memory of the device 100, and is only evaluated by the device in order to determine its nature. The ability of the device to continue to register image data captured via the element 103 may be dependent on a mode of the device. For example, if the device 100 is placed by a user into an image capture mode, or a videoconference mode for example, the registration of data may be initiated. However, if the device 100 is in a mode in which an imaging function of the device may not be utilised due to the nature of the mode itself, registration of image data may not be initiated.

In a preferred embodiment, the device is able to determine if the data registered corresponds to data representing the image of a human face, in which case it may override any prohibition of an imaging function. For example, if the device 100 determines that data registered via the imaging element 103 corresponds to data representing the image of a human face, and that the face in the registered image is substantially centrally located within a predetermined area suitable for the initiation of videoconferencing, for example, the prohibition of the imaging function may be overridden. The predetermined area may be a substantially centrally located portion of the image capture element for example, or another portion, providing that it indicates that a user of the device wishes to initiate an imaging function of the device for personal reasons. In this manner, a portion of an image relating to the face of a user registered in a corner or over an edge of the image capture element will generally not cause the device to fully enable an imaging function, as it will be more than likely that such an image has been registered as a result of a user simply moving the device unintentionally in front of their face for example.

In addition, and in order to add a security feature, the device 100 may be operable to determine whether the registered image data corresponds to data representing the image of a face of a certified user of the device 100, such as the owner of the device, or someone who is permitted to use the device by the owner for example. In such a case, a prohibition of an imaging function could be overridden, otherwise, the prohibition would continue to bar the correct functioning of the imaging function of the device.

As a further security feature, upon recognition by the device 100 that data registered by the device 100 corresponds to data of the image a face of certified user, and that the face in the registered image is substantially centrally located within a predetermined area suitable for the initiation of videoconferencing, for example, the device 100 may then prompt such a user to provide additional verification for security purposes. For example, the user may have to enter a personal identification number or similar, or, if the device 100 has biometric functionality, it may prompt the user to provide a biometric signature to the device using a fingerprint scanner for example in order to verify that the user is a certified user of the device.

Upon successful registration of data representing the image of a face of a certified user, and correct entry of any additional security requirements, an imaging function of the device may be enabled for use. Otherwise, the device may disable an imaging function for a predetermined amount of time as will be described below.

Accordingly, in a preferred embodiment, the device 100 of FIG. 1 includes the necessary functionality in order to be able to identify an image of the face of a certified user of the device 100. When the device is in a suitable mode of operation, such as a videoconferencing mode for example, and when the device is in an area in which imaging functions of image capture devices are disabled, the element 103 of the device 100 is still operable to register image data, and a processor of the device 100 is operable to determine if any registered data corresponds to data representing an image of the face of a certified user of the device.

Stored data corresponding to that of an image of a face of a certified user of the device, or more generally of a face of a person, and which is used for comparison against the registered image data may be stored in a memory of the device (not shown). Such a memory may be a device-internal memory such as a dynamic random-access memory (DRAM) and may include either non-volatile memory (e.g., flash, ROM, PROM, etc.) and/or removable memory (e.g., memory cards, disks, etc.). Alternatively, the relevant comparison data may be stored in a device-external memory such as a memory at a location remote from the device. In this case, a comparison against any registered image data may be performed in the device itself upon retrieval of the remotely stored data via a wireless communications network or a hard wired link to a communications network, or may be carried out remotely such that a comparison against registered image data is performed at a location remote from the device. In this case, the registered image would be sent to the remote location using one of the above mentioned network links in order to facilitate the comparison. Results of the comparison may then be sent back to the device via the network link.

The enablement of the imaging function of the device 100 will override the prohibition of use of the imaging function in the area in question so that the device, and the imaging element, may be used in order to perform specified personal tasks such as using the device for videoconferencing and the like.

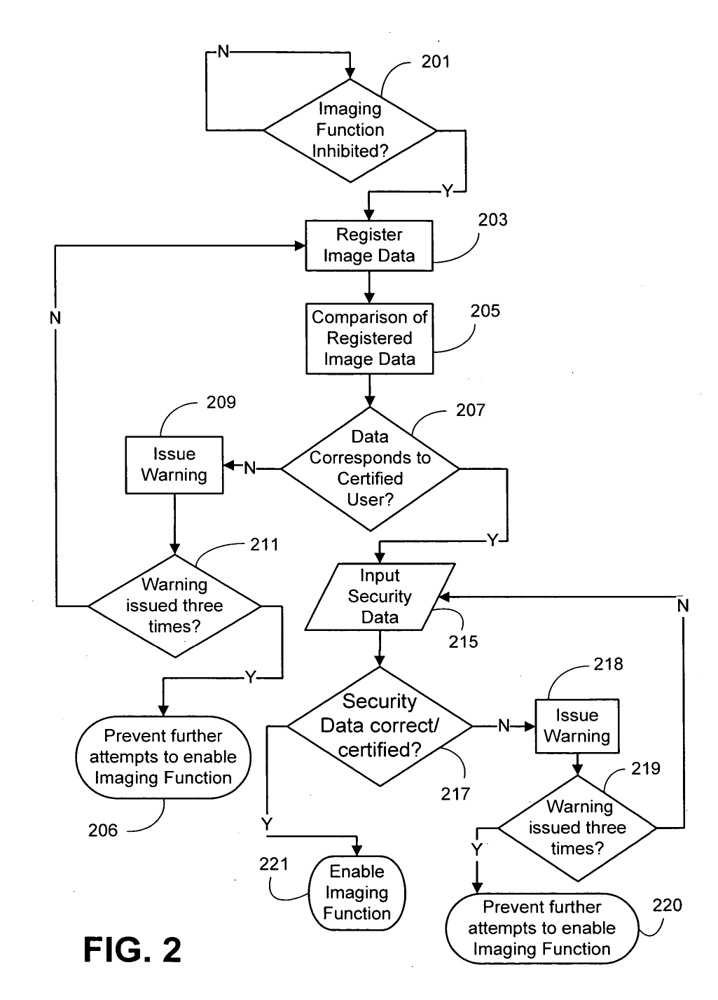

FIG. 2 is a flow chart representing a process followed by a device according to an exemplary embodiment.

At step 201, a device determines that it is in an area in which imaging functions are inhibited. This may be due to reception of a signal by the device indicating such prohibitions are in effect in the immediate area for example.

At step 203, image data representing an image of a face of a user of a device is registered by the device via an image capture element of the device.

At step 205, the registered data is compared to data which is stored in a memory associated with the device. If, at step 207, it is determined that the data does not correlate with the stored data, the device may issue a warning (step 209), audible or visual on a screen of the device (not shown) for example, to the user that they have not been recognised by the device. This may be due to the fact that the user is not a registered user of the device, or that the device has failed to recognise that the registered data represents an image of a face.

In an exemplary embodiment, if the comparison at step 205 fails three times in succession such that a warning is issued three times (step 211), for example, the device may prevent any further attempts to enable an imaging function (step 206) within a given period of time, such as one hour, for example. Other alternatives are possible. For example, a failure of a given number of times at step 205 may cause the device to become inoperable indefinitely until it is ‘unlocked’, either by a certified user or by a third party authorised to remove the inoperability.

If it is determined at step 207 that the registered image data does correlate with data stored in a memory associated with the device as that representing an image of a face in the correct positioning as described above, the device may enable an imaging function of the device at step 221 or optionally, at step 215, prompt the user to enter additional security data (step 217).

At step 217, if the security data input by a user is incorrect, a device may issue a warning, audible or visual or combination thereof at step 218, and prompt the user to re-input such data (step 215). If such data is input incorrectly three times, for example at step 219, the device may prevent further attempts to enable an imaging function (step 220) within a given period of time such as that described above with respect to step 206. The data used for validating the input security data may be stored in the same manner and location, or at a different location to the data used to validate if a registered image represents that of a face

If the data is input correctly, the device will enable an imaging function (step 221).

According to a further embodiment, once it has been determined by the device using a procedure such as that outlined above with reference to FIG. 2, that image data registered by a device represents the image of a face of a user of the device, and more specifically, the face of a certified user of the device, and once the device has accordingly enabled an imaging function of the device, any image data peripheral to that of the face of the user incident on an imaging element of the device may be processed in order to obscure all or a portion of it with respect to the image of the face of the user. Such obscuration may be effected by blurring for example.

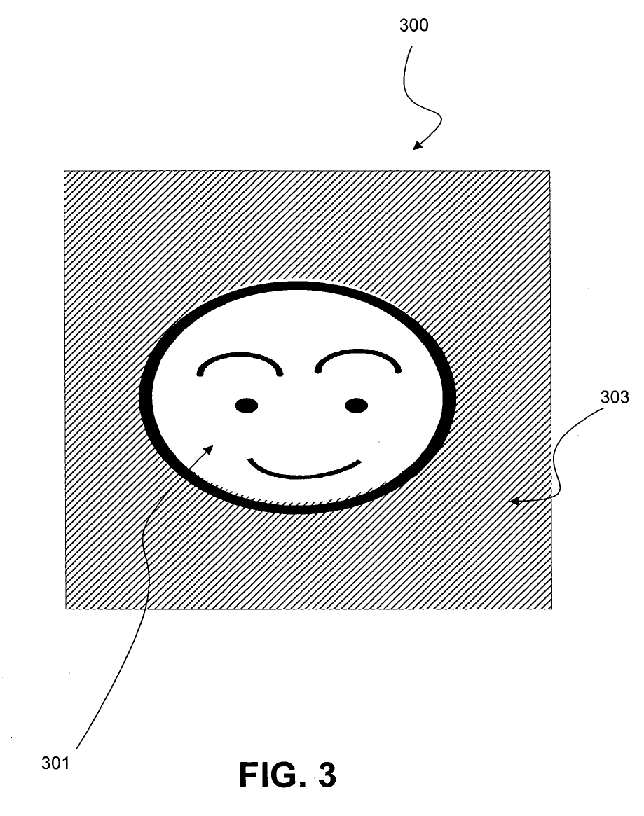

FIG. 3 of the accompanying drawings is a diagrammatic representation of an image which has been processed to blur a portion of the image. This image will be that which is transmitted from a device such as that described above with reference to FIGS. 1 and 2 of the accompanying drawings to a remote device or terminal (not shown) for display on that device or terminal for the purposes of videoconferencing for example.

The portion 301 of the image 300 of FIG. 3 represents the image of a face of a user of the device (not shown). The portion of the image 303 is a blurred portion of the image 300. The portion 303 (hashed portion) is blurred in order to obscure any image data which may represent people in the background who may object to having their image broadcast in such a manner.

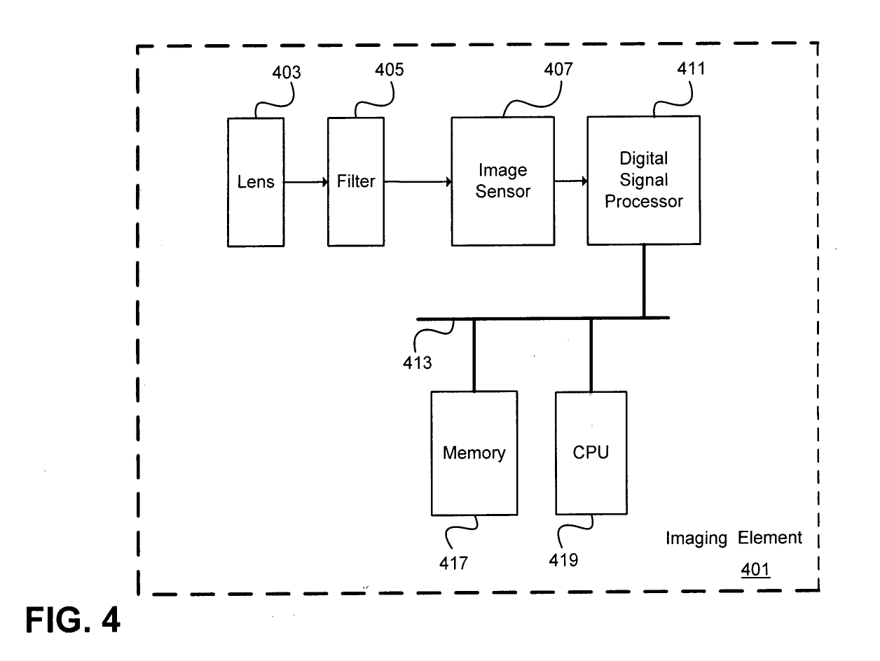

FIG. 4 of the accompanying drawings is a diagrammatic representation of some elements of an exemplary mobile device operable in accordance with the present method. More specifically, FIG. 4 represents an exemplary imaging module of a mobile device.

The imaging element 401 comprises a lens assembly 403, a filter 405, image sensor 407, and a digital signal processor 411. An image or scene of interest is captured from light passing through the lens assembly 403. The light may be filtered using the filter 405. The image is then converted into an electrical signal by image sensor 407 which could be either of the devices mentioned above. The raw image data is then passed to the digital signal processor (DSP) 411.

Further, with reference to the device 401 of FIG. 4, a bus, or similar, 413 is operable to transmit data and/or control signals between the DSP 411, memory 417, and the central processing unit (CPU) 419.

Memory 417 may be dynamic random-access memory (DRAM) and may include either non-volatile memory (e.g., flash, ROM, PROM, etc.) and/or removable memory (e.g., memory cards, disks, etc.). Memory 417 may be used to store raw image digital data as well as processed image digital data. CPU 419 is a processor which can be programmed to perform various tasks associated with the device 401.

It should be noted that there are many different configurations for the imaging element of FIG. 4. In one embodiment, the CPU 419 and the DSP 411 may reside on a single chip, for example. In other embodiments, the CPU 419 and DSP 411 reside on two or more separate chips, for example. Further combinations are possible, but it should be noted that the exact architecture of the imaging element 401 and/or the components therein as outlined above are not intended to be limiting, and are merely presented in order to exemplify the typical image capture elements of a mobile device with which the present method will function.

For example, the CPU 419 may be in addition to a CPU of the mobile device, or may perform tasks additional to those as required by the imaging element. Memory 417 may also be used for other functions of the mobile device for example.

Comparison of data referred to herein may be effected using known techniques, either in the device itself, or externally. Such comparison techniques may include a simple pixel by pixel comparison of registered and stored image data taking account of any differences due to lighting conditions and the location of the registered image with respect to the image element for example, or may involve more sophisticated techniques in which certain elements of an, image are compared with stored data in order to determine if such registered data represents the image of a human face for example. Such elements may be facial features corresponding generally to a face, or more specifically to the face of a certified user for example. Alternatively, other elements of a registered image may be compared to stored data in order to effect the comparison.

1. A mobile device including a processor, the processor operable to determine if use of an imaging function of an image capture element of the device is prohibited, wherein, on the basis of the determination, the processor is adapted to process image data registered using the image capture element in order to facilitate determination that the registered image data corresponds to data stored in a memory associated with the device and is further operable to enable the imaging function of the device on the basis of this determination.

2. A mobile device as claimed in claim 1, wherein the memory is a device-internal memory, and the processor is operable to effect the determination.

3. A mobile device as claimed in claim 2, wherein the processor is operable to process the results of the determination.

4. A mobile device as claimed in claim 1, wherein the memory is a device-external memory, and the determination is executed externally from the device.

5. A mobile device as claimed in claim 4, wherein the processor is operable to process the results of the determination.

6. A mobile device as claimed in claim 1, wherein the processor is operable to determine if use of the imaging function of the image capture element of the device is prohibited by means of the reception of a prohibition signal by the device.

7. A method of enabling an imaging function of a mobile device, the method including:
determining if use of the imaging function of an image capture element of the device is prohibited;
on the basis of the determination, registering image data using the image capture element of the device;
processing the registered image data;
determining, on the basis of the processing, if the registered image data corresponds to data stored in a memory associated with the device; and
enabling the imaging function of the device on the basis of this determination.

8. A method a claimed in claim 7, wherein the data stored in the memory associated with the device includes data relating to an image of a human face.

9. A method as claimed in claim 8, further including determining if data relating to the image of a face indicates that the face is substantially centrally located within a predetermined area of the image capture element.

10. A method as claimed in claim 7, wherein said determination, on the basis of the processing, includes determining if said registered data is data representing an image of a face.

11. A method as claimed in claim 10, including disabling the imaging function of the image capture element of the device for a predetermined amount of time in the event that the registered image data does not correspond to data relating to the image of the face of the certified user of the device.

12. A method as claimed in claim 7, including determining if the registered image data corresponds to data relating to an image of a face of a certified user of the device.

13. A method as claimed in claim 7, further including prompting a user of the device for an input of verification data.

14. A method as claimed in claim 13, wherein said verification data includes at least one of a personal identification numeric, alpha or alphanumeric sequence, or a biometric signature.

15. A method as claimed in 13, including disabling the imaging function of the image capture element of the device for the predetermined amount of time in the event that the verification data input to the device does not correspond to stored verification data.

16. A method as claimed in claim 7, further including obscuring a portion of the image captured using the image capture element of the device following the enablement of the imaging function.

17. A method as claimed in claim 7, further including placing the device into a suitable mode of operation for enablement of the imaging function of the image capture element of the device.

18. A method as claimed in claim 17, wherein placing the device into the suitable mode of operation for enablement of the imaging function of the image capture element of the device occurs either before or after determining if use of the imaging function of the image capture element of the device is prohibited.

19. A method as claimed in claim 7, wherein the determining, on the basis of the processing, is executed on-board the mobile device.

20. A method as claimed in claim 7, wherein the determining, on the basis of the processing, is executed external to the mobile device.

21. A method as claimed in claim 20, wherein the results of the determination are sent to the mobile device.

22. A method as claimed in claim 21, wherein sending the results of the determination to the mobile device is effected using one of either a wireless telecommunications network or a hard-wired network.

23. A system that enables an imaging function of a mobile device; comprising:
an image capture element that captures image information of a user;
a central processing unit (CPU) adapted to determine if use of the imaging function of the device is prohibited, and on the basis of the determination, registering image data using the image capture element of the device;
a memory for storing the registered image data;
such that, on the basis of the processing, if the registered image data corresponds to data stored in the memory, the imaging function of the device is enabled on the basis of this determination.

24. A mobile device including:
means for determining if use of an imaging function of an image capture element of the device is prohibited;
means for registering image data using the image capture element of the device;
means for processing the registered image data;
means for determining if the registered image data corresponds to data stored in a memory associated with the device; and
means for enabling an imaging function of the device.
